(19) United States
(12) Patent Application Publication
(10) Pub. No.: US 2024/0278230 A1
(43) Pub. Date: Aug. 22, 2024

(54) MICROFLUIDIC CHIP, DROPLET GENERATION DEVICE AND METHOD FOR CONTROLLING DROPLET GENERATION SIZE

(71) Applicant: BOE TECHNOLOGY GROUP CO., LTD., Beijing (CN)

(72) Inventors: Yunqing Mu, Beijing (CN); Ding Ding, Beijing (CN)

(21) Appl. No.: 18/044,296

(22) PCT Filed: May 13, 2022
(86) PCT No.: PCT/CN2022/092641

§ 371 Date: Mar. 7, 2023

(51) Int. Cl. B01L 3/02

(52) U.S. Cl. CPC B01L 3/0265; B01L 2200/027; B01L 2400/02; B01L 2400/0677

(57) ABSTRACT

The disclosure provides a microfluidic chip, a droplet generation device and a method for controlling a droplet generation size. The microfluidic chip includes a substrate and a first flow channel, a second flow channel and a third flow channel distributed on the substrate, the first flow channel, the second flow channel and the third flow channel intersecting to form a confluence area, the first flow channel being configured for a flow of a dispersed phase fluid from it, the second flow channel being configured for a flow of a continuous phase fluid from it, the dispersed phase fluid and the continuous phase fluid forming droplets in the third flow channel. The dispersed phase fluid flows in the first flow channel along a first direction, an orthographic projection of the first flow channel on the substrate has a first width which is constant in a second direction.

### RELATED APPLICATIONS

The present application is a 35 U.S.C. 371 national stage application of PCT International Application No. PCT/CN2022/092641, filed on May 13, 2022, the entire disclosure of which is incorporated herein by reference.

### TECHNICAL FIELD

The present disclosure relates to the field of biomedical detection, in particular to a microfluidic chip, a droplet generation device and a method for controlling a droplet generation size.

### BACKGROUND

Microfluidic chip is an important carrier and tool for droplet generation. By adding auxiliary samples such as surfactants into two immiscible liquids, the effect of one phase being dispersed into another phase and forming droplets is finally achieved. As a new technology, microfluidic droplets are most commonly used as micro-reactors to study the reactions and processes on the micro scale. The reactions here generally refer to various chemical reactions, biochemical reactions and processes involving phase transformation, such as protein crystallization and synthesis of nanoparticles. With the continuous development and improvement of technology, the application of microfluidic droplets is more and more extensive. As a microreactor, liquid droplets have the advantages of small volume, no diffusion of samples, stable reaction conditions, avoiding cross contamination between samples, and rapid mixing.

### SUMMARY

According to an aspect of the present disclosure, a microfluidic chip is provided. The microfluidic chip comprises a substrate and a first flow channel, a second flow channel and a third flow channel distributed on the substrate, the first flow channel, the second flow channel and the third flow channel intersecting to form a confluence area, the first flow channel being configured for a flow of a dispersed phase fluid from it, the second flow channel being configured for a flow of a continuous phase fluid from it, the dispersed phase fluid and the continuous phase fluid forming droplets in the third flow channel, wherein the dispersed phase fluid flows in the first flow channel along a first direction, an orthographic projection of the first flow channel on the substrate has a first width which is constant in a second direction, and the second direction and the first direction are perpendicular to each other in a plane of the substrate; the formed liquid droplets flow in the third flow channel along a third direction, the third flow channel comprises a volume variable part extending along the third direction, an orthographic projection of the volume variable part on the substrate has an adjustable width in a fourth direction, the fourth direction and the third direction are perpendicular to each other in the plane of the substrate, droplets of different sizes are generated by controlling a ratio of the adjustable width to the first width.

In some embodiments, the adjustable width has a second width which is constant along the third direction.

In some embodiments, the first direction is in a same line with the third direction.

In some embodiments, a ratio of the second width to the first width is between 0.5-1.

In some embodiments, a droplet size is approximately linear with the ratio of the second width to the first width.

In some embodiments, a viscosity ratio of the continuous phase fluid to the dispersed phase fluid is in a range of 10:1-50:1, and a surface tension coefficient between the two after adding surfactant is in a range of 1×10⁻³˜1×10⁻² N/m, the droplet size is approximately positively correlated linear with the ratio of the second width to the first width.

In some embodiments, the volume variable part extends a first length along the third direction, and the adjustable width gradually decreases and then increases along the first length.

In some embodiments, a ratio of a minimum width to a maximum width is between 0.5-1, and the first length is 2-5 times the minimum width.

In some embodiments, the maximum width is equal to the first width.

In some embodiments, the minimum width is at a midpoint of the first length.

In some embodiments, the minimum width is at a position closer to the confluence area than a midpoint of the first length.

In some embodiments, the minimum width is at a position farther from the confluence area than the midpoint of the first length.

In some embodiments, the orthographic projection of the volume variable part on the substrate is a center-symmetric pattern, and a distance between tangents of two curved edges of the center-symmetric pattern is half of the maximum distance between the two curved edges.

In some embodiments, the first width is 100 microns.

In some embodiments, the volume variable part of the third flow channel comprises volume phase change material.

In some embodiments, the volume phase change material achieves the adjustable width in response to at least one condition change in magnetic field, electric field, temperature and pressure.

In some embodiments, the volume phase change material comprises at least one of a polymer brush, a polymer gel or an elastic material.

In some embodiments, the dispersed phase is an aqueous phase, the continuous phase is an oil phase, and the liquid droplet has a water-in-oil structure.

According to another aspect of the present disclosure, a droplet generation device is provided, the droplet generation device comprises the microfluidic chip according to any one of the above embodiments.

In some embodiments, the droplet generation device further comprises a pumping device, which is connected with the first flow channel and the second flow channel to control a flow rate of the dispersed phase entering the first flow channel and a flow rate of the continuous phase entering the second flow channel.

According to yet another aspect of the present disclosure, a method for controlling a droplet generation size is provided. The method comprises: providing the microfluidic chip according to any one of the above embodiments; controlling the volume variable part of the third flow channel to realize a first volume change, and obtaining a first size of a generated liquid droplet; controlling the volume variable part of the third flow channel to realize a second volume change, and obtaining a second size of a generated liquid droplet; controlling the volume variable part of the third flow channel to realize a n-th volume change, and obtaining a n-th size of a generated liquid droplet, where n≥3; and obtaining a first relationship between the ratio of the adjustable width to the first width and the droplet size; controlling the adjustable width based on the first relationship to obtain droplets of a required size.

In some embodiments, after obtaining the first relationship between the ratio of the adjustable width to the first width and the droplet size, the method further comprises: with the ratio of the adjustable width to the first width determined, adjusting at least one of a dispersed phase flow rate and a continuous phase flow rate to obtain a second relationship between the dispersed phase flow rate and the continuous phase flow rate and the droplet size; and controlling at least one of the adjustable width, the dispersed phase flow rate and the continuous phase flow rate based on the first relationship and the second relationship to obtain droplets of the required size.

In some embodiments, a ratio of the dispersed phase flow rate to the continuous phase flow rate is in a range of 1:2-1:4.

### BRIEF DESCRIPTION OF THE DRAWINGS

In order to more clearly illustrate the technical solutions in embodiments of the disclosure or in the prior art, the appended drawings needed to be used in the description of the embodiments or the prior art will be introduced briefly in the following. Obviously, the drawings in the following description are only some embodiments of the disclosure, and for those of ordinary skills in the art, other drawings may be obtained according to these drawings under the premise of not paying out creative work.

FIG. 1 shows a plane structure diagram of the microfluidic chip according to an embodiment of the present disclosure;

FIG. 2A shows a plan view of a flow channel structure of the microfluidic chip according to an embodiment of the present disclosure;

FIG. 2B is a droplet distribution diagram of the flow channel structure in FIG. 2A calculated by cfd;

FIG. 3A shows another plan view of a flow channel structure of the microfluidic chip according to an embodiment of the present disclosure;

FIG. 3B is a droplet distribution diagram of the flow channel structure in FIG. 3A calculated by cfd;

FIG. 4A shows another plan view of a flow channel structure of the microfluidic chip according to an embodiment of the present disclosure;

FIG. 4B is a droplet distribution diagram of the flow channel structure in FIG. 4A calculated by cfd;

FIG. 5A shows another plan view of a flow channel structure of the microfluidic chip according to an embodiment of the present disclosure;

FIG. 5B is a droplet distribution diagram of the flow channel structure in FIG. 5A calculated by cfd;

FIG. 6A shows another plan view of a flow channel structure of the microfluidic chip according to an embodiment of the present disclosure;

FIG. 6B is a droplet distribution diagram of the flow channel structure in FIG. 6A calculated by cfd;

FIG. 7A shows another plan view of the flow channel structure of the microfluidic chip according to an embodiment of the present disclosure;

FIG. 7B is a droplet distribution diagram of the flow channel structure in FIG. 7A calculated by cfd;

FIG. 8 shows a relationship curve between the droplet size and the second width/first width according to an embodiment of the present disclosure;

FIG. 9A shows another plan view of the flow channel structure of the microfluidic chip according to an embodiment of the present disclosure;

FIG. 9B shows another plan view of the flow channel structure of the microfluidic chip according to an embodiment of the present disclosure;

FIG. 9C shows another plan view of the flow channel structure of the microfluidic chip according to an embodiment of the present disclosure;

FIG. 9D shows another plan view of the flow channel structure of the microfluidic chip according to an embodiment of the present disclosure;

FIG. 10A shows specific dimensions of the flow channel structure shown in FIG. 9A;

FIG. 10B shows specific dimensions of the flow channel structure shown in FIG. 9B;

FIG. 10C shows specific dimensions of the flow channel structure shown in FIG. 9C;

FIG. 10D shows specific dimensions of the flow channel structure shown in FIG. 9D;

FIG. 11 is a droplet distribution diagram of the channel structure with configuration 3 calculated by cfd;

FIG. 12 is a flowchart of a method for controlling a droplet generation size according to an embodiment of the present disclosure; and

FIG. 13 is another flowchart of a method for controlling a droplet generation size according to an embodiment of the present disclosure.

### DETAILED DESCRIPTION OF THE DISCLOSURE

In the following, the technical solutions in the embodiments of the disclosure will be described clearly and completely in connection with the drawings in the embodiments of the disclosure. Obviously, the described embodiments are only part of the embodiments of the disclosure, and not all of the embodiments. Based on the embodiments in the disclosure, all other embodiments obtained by those of ordinary skills in the art under the premise of not paying out creative work pertain to the protection scope of the disclosure.

Droplet-based microfluidic technology is a powerful high-throughput method, which is widely used in the fields of single-cell analysis, next-generation sequencing systems, molecular diagnosis and drug screening. Different microfluidic chips have different requirements for the size of droplets. For example, when the microfluidic droplets are used for single-cell separation, the size of different tissue cells being separated is different, and different requirements for the size of droplets are also put forward. Even the microfluidic chips for the same purpose have different requirements for the size of droplets. At the same time, since the droplet size is affected by many factors such as experimental conditions, material properties and flow channel structure, the generated droplet size can not be accurately estimated. In the actual operation process, it is often necessary to repeatedly adjust various experimental conditions to finally generate the required size droplet, which brings many inconveniences to the user.

To this end, embodiments of the present disclosure provide a microfluidic chip, a droplet generation device and a method for controlling a droplet generation size to overcome problems mentioned above.

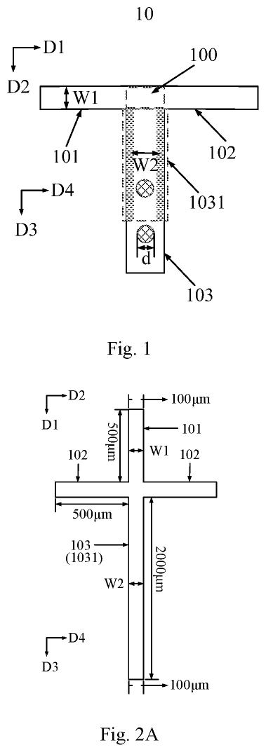

FIG. 1 shows a plane structure diagram of the microfluidic chip according to an embodiment of the present disclosure. As shown in FIG. 1, the microfluidic chip 10 includes: a substrate and a first flow channel 101, a second flow channel 102 and a third flow channel 103 distributed on the substrate. The first flow channel 101, the second flow channel 102 and the third flow channel 103 intersect to form a confluence area 100, the first flow channel 101 is configured for a flow of dispersed phase fluid from it, and the second flow channel 102 is configured for a flow of continuous phase fluid from it. The dispersed phase fluid and the continuous phase fluid form droplets 200 in the third flow channel 103. The dispersed phase fluid flows in the first flow channel 101 along a first direction D1, an orthographic projection of the first flow channel on the substrate has a first width W1 which is constant in the second direction D2, and the second direction D2 is perpendicular to the first direction D1. The formed droplets flow in the third flow channel along the third direction D3. The third flow channel includes a volume variable part 1031 extending along the third direction D3. An orthographic projection of the volume variable part 1031 on the substrate has an adjustable width W2 in the fourth direction D4, and the fourth direction D4 is perpendicular to the third direction D3. By controlling the ratio of the adjustable width W2 to the first width W1, droplets of different sizes can be generated.

The microfluidic chip proposed in the present disclosure has a volume variable part in the flow channel that forms droplets, i.e., the third flow channel. By controlling the deformation of the volume variable part, the size of the flow channel can be rapidly changed, thus changing the size of the generated droplets. By controlling the ratio of the adjustable width to the first width, droplets of various sizes can be rapidly prepared on the same chip. Thus, the problem of long droplet preparation time caused by replacing a large number of experimental chips with different structures is avoided, and the requirements for high throughput and automation in clinical detection are met.

According to the difference between dispersed phase and continuous phase, liquid droplets can be divided into two types, W/O type and O/W type. The W/O type droplet takes the water phase as the dispersed phase and the oil phase as the continuous phase; the O/W type droplet takes the oil phase as the dispersion phase and the water phase as the continuous phase. The water phase refers to various aqueous solutions, while the oil phase refers to various organic solvents insoluble in water. Water solution and oil flow out from different micro channels at the same time. When the flow channel is hydrophobic, the oil wets the channel and wraps the water solution to form water-in-oil (W/O) type droplets; when the flow channel is hydrophilic, water wets the flow channel and wraps the oil solution to form oil-in-water (O/W) type droplets. The present disclosure does not specify the type of droplet. In addition, it can be understood that droplets generally have irregular shapes. In this disclosure, “droplet size” refers to the maximum width of the droplet in the direction perpendicular to the flow direction of the droplet.

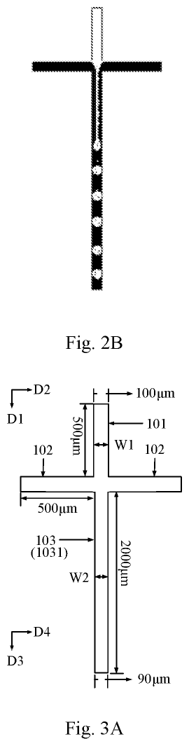

FIG. 1 schematically shows a T-shaped flow channel structure, that is, the inflow direction D1 of the dispersed phase is perpendicular to the outflow direction D3 of the droplet, while FIG. 2A-Fig. 7B below schematically show the cross-shaped flow channel structures, that is, the inflow direction D1 of the dispersed phase and the outflow direction D3 of the droplet are in a straight line. It should be noted that the T-shaped flow channel structure and the cross-shaped flow channel structure are the two most common and widely used microfluidic droplet generation structures at present, but the embodiments shown in the drawings are only schematic, the specific structure of the flow channel in the present disclosure is not specifically limited, for example, the included angle between the first flow channel, the second flow channel and the third flow channel can be any angle in the range of 0-180°.

In some embodiments, as shown in FIG. 1, the volume variable part 1031 is on a part of the third flow channel 103 near the confluence area 100. In some embodiments, as shown in FIG. 2A-FIG. 7B, the volume variable part 1031 may be on the entire length of the third flow channel 103. The present disclosure does not specify the position and length of the volume variable part distributed on the third flow channel.

Using the microfluidic chip provided by the present disclosure, the relationship curve between the ratio of the adjustable width to the first width and the size of the generated droplet is obtained under certain experimental conditions. In the subsequent experiments under the same experimental conditions, the flow channel structure can be selected or controlled relatively quantitatively according to the given relationship curve to generate the desired size of droplets.

According to some embodiments of the present disclosure, the volume variable part can be distributed on the entire third flow channel, and the width of the third flow channel can be controlled to change as a whole by external conditions, that is, the entire third flow channel has a uniform second width. When a viscosity ratio of the continuous phase fluid to the dispersed phase fluid is in a range of 10:1-50:1, the surface tension coefficient between the two after adding surfactant is in a range of 1×10⁻³˜1×10⁻² N/m, by adjusting the ratio of the second width to the first width to be within the range of 0.5-1, the droplet size is approximately positively correlated linear with the ratio of the second width to the first width, y=ax+b, where y is the droplet size in microns, x is the ratio of the second width to the first width, and a>0. Because of their approximate linear relationship, it is easier to control the specific conditions, so as to obtain the required size of the droplets.

The following specific embodiments are used to illustrate the process of preparing droplets of different sizes using the chip provided by the present disclosure. The following examples all use the same experimental materials, in which the dispersed phase is the water phase, the viscosity of the water phase is 0.001 kg/m/s, the continuous phase is the oil phase, the viscosity of the oil phase is 0.04 kg/m/s, and the surface tension coefficient between the two after adding surfactant is 0.004 n/m. The cross-shaped flow channel structure is adopted. The length of the first flow channel can be greater than or equal to 500 microns, such as 500 microns, 550 microns, 600 microns, 650 microns, 700 microns, 750 microns, etc. The length of the two second flow channels on both sides of the first flow channel can be greater than or equal to 500 microns, such as 500 microns, 550 microns, 600 microns, 650 microns, 700 microns, 750 microns, etc. The length of the third flow channel can be greater than or equal to 2000 microns, such as 2000 microns, 2500 microns, 3000 microns, 3500 microns, 4000 microns, 4500 microns, etc. The width of the first flow channel can be 100 microns, the water phase flows into the first flow channel at a flow rate of 0.004 m/s, and the oil phase flows into the second flow channel at a flow rate of 0.008 m/s from the left and right sides at the same time. Through the combined action of shear force and surface tension, it forms a W/O type droplet and flows out from the third flow channel.

As shown in FIG. 2A-FIG. 7B, the volume variable part can be distributed on the entire third flow channel 103, and the width of the third flow channel 103 can be controlled to change as a whole by external conditions, that is, the entire third flow channel has a uniform second width W2.

FIG. 2A shows a plan view of the flow channel structure of the microfluidic chip according to an embodiment of the present disclosure. In the case shown in FIG. 2A, the ratio of the second width W2 to the first width W1 is 1. The length of the first flow channel is 500 microns and the width W1 is 100 microns; the length of the second flow channel on both sides of the confluence area is 500 microns respectively and the width is 100 microns; the length of the third flow channel is 2000 microns, and the width W2 is 100 microns. Through computational fluid dynamics (cfd) simulation, the size of droplets formed in the channel structure can be obtained. FIG. 2B is a droplet distribution diagram of the flow channel structure in FIG. 2A calculated by cfd. The size of the generated droplets is 68 microns.

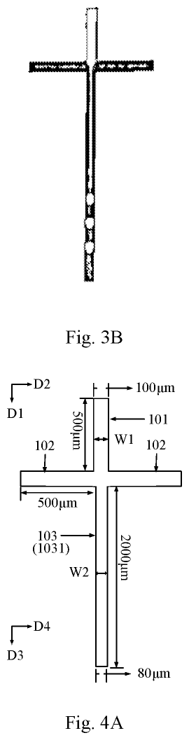

FIG. 3A shows another plan view of a flow channel structure of the microfluidic chip according to an embodiment of the present disclosure. In the case shown in FIG. 2A, the ratio of the second width W2 to the first width W1 is 0.9. The length of the first flow channel is 500 microns and the width W1 is 100 microns; the length of the second flow channel on both sides of the confluence area is 500 microns and the width is 100 microns; the length of the third flow channel is 2000 microns and the width W2 is 90 microns. Through cfd simulation, the size of droplets formed in the channel structure can be obtained. FIG. 3B is a droplet distribution diagram of the flow channel structure in FIG. 3A calculated by cfd. The size of the generated droplets is 66 microns.

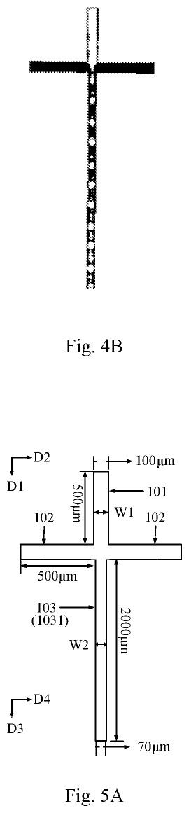

FIG. 4A shows another plan view of a flow channel structure of the microfluidic chip according to an embodiment of the present disclosure. In the case shown in FIG. 4A, the ratio of the second width W2 to the first width W1 is 0.8. The length of the first flow channel is 500 microns and the width W1 is 100 microns; the length of the second flow channel on both sides of the confluence area is 500 microns and the width is 100 microns; the length of the third flow channel is 2000 microns and the width W2 is 80 microns. Through cfd simulation, the size of droplets formed in the channel structure can be obtained. FIG. 4B is a droplet distribution diagram of the flow channel structure in FIG. 4A calculated by cfd. The size of the generated droplets is 54 microns.

FIG. 5A shows another plan view of a flow channel structure of the microfluidic chip according to an embodiment of the present disclosure. In the case shown in FIG. 5A, the ratio of the second width W2 to the first width W1 is 0.7. The length of the first flow channel is 500 microns and the width W1 is 100 microns; the length of the second flow channel on both sides of the confluence area is 500 microns and the width is 100 microns; the length of the third flow channel is 2000 microns and the width W2 is 70 microns. Through cfd simulation, the size of droplets formed in the channel structure can be obtained. FIG. 5B is a droplet distribution diagram of the flow channel structure in FIG. 5A calculated by cfd. The size of the generated droplets is 54 microns.

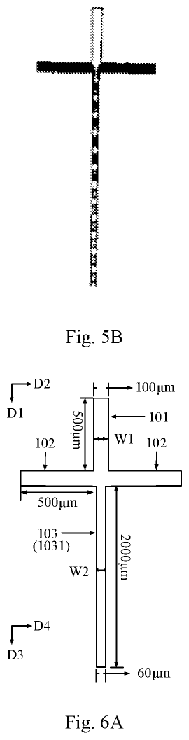

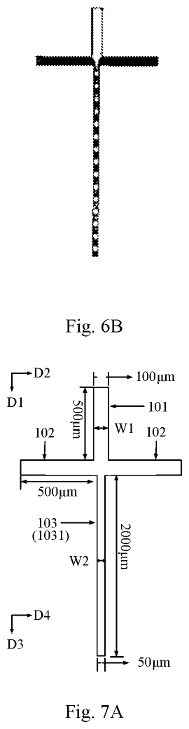

FIG. 6A shows another plan view of a flow channel structure of the microfluidic chip according to an embodiment of the present disclosure. In the case shown in FIG. 6A, the ratio of the second width W2 to the first width W1 is 0.6. The length of the first flow channel is 500 microns and the width W1 is 100 microns; the length of the second flow channel on both sides of the confluence area is 500 microns and the width is 100 microns; the length of the third flow channel is 2000 microns and the width W2 is 60 microns. Through cfd simulation, the size of droplets formed in the channel structure can be obtained. FIG. 6B is a droplet distribution diagram of the flow channel structure in FIG. 6A calculated by cfd. The size of the generated droplets is 38 microns.

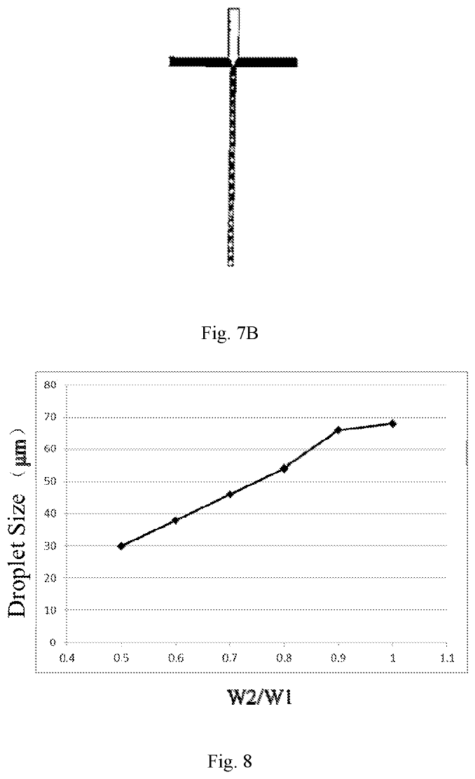

FIG. 7A shows another plan view of the flow channel structure of the microfluidic chip according to an embodiment of the present disclosure. In the case shown in FIG. 7A, the ratio of the second width W2 to the first width W1 is 0.5. The length of the first flow channel is 500 microns and the width W1 is 100 microns; the length of the second flow channel on both sides of the confluence area is 500 microns and the width is 100 microns; the length of the third flow channel is 2000 microns and the width W2 is 50 microns. Through cfd simulation, the size of droplets formed in the channel structure can be obtained. FIG. 7B is a droplet distribution diagram of the flow channel structure in FIG. 7A calculated by cfd. The size of the generated droplets is 30 microns.

Based on the above specific embodiments, the relationship between the droplet size and the ratio of the second width W2 to the first width W1 can be obtained. FIG. 8 shows a relationship curve between the droplet size and the second width/first width according to an embodiment of the present disclosure. It can be obtained by fitting that when the ratio of the second width to the first width is between 0.5-1, the droplet size and the second width/the first width are approximately linear: y=80x−10, where y is the droplet size in microns, and x is the ratio of the second width to the first width. Because of their approximate linear relationship, it is easier to control the specific conditions, so as to obtain the required size of the droplets.

The conventional body cell size is between ten to tens of microns. Under the above experimental conditions, by adjusting the ratio of the second width to the first width to be within the range of 0.5-1, for example, the ratio is 0.5, 0.55, 0.6, 0.65, 0.7, 0.75, 0.8, 0.85, 0.9, 0.95, 1, and so on, the droplets with the size of 30-70 microns can be obtained, for example, the size is about 30 microns, 34 microns, 38 microns, 42 microns, 46 microns, 50 microns, 54 microns, 58 microns 62 microns, 66 microns, 70 microns, etc. In this way, it can basically meet the requirements for the size of droplets that can wrap single-cell in the actual experiment.

In some embodiments, when the ratio of the second width to the first width is fixed, the generated droplet size can also be controlled by adjusting the flow rate of the dispersed phase and the continuous phase. Table 1 shows different droplet sizes generated by adjusting the water phase flow rate V2 with the oil phase flow rate V1 unchanged when the ratio of the second width to the first width is 1. Table 2 shows different droplet sizes generated by adjusting the oil phase flow rate V1 with the water phase flow rate V2 unchanged when the ratio of the second width to the first width is 1. Table 3 shows different droplet sizes generated by adjusting the water phase flow rate V2 with the oil phase flow rate V1 unchanged when the ratio of the second width to the first width is 0.5. Table 4 shows different droplet sizes generated by adjusting the oil phase flow rate V1 with the water phase flow rate V2 unchanged when the ratio of the second width to the first width is 0.5.

TABLE 1
v1 = 0.016 m/s

| | v2:v1 = 1:2 | v2:v1 = 1:3 | v2:v1 = 1:4 |
|---|---|---|---|
| | v2 = 0.008 m/s | v2 = 0.00533 m/s | v2 = 0.004 m/s |
| droplet | 58 | 46 | 48 |
| size (μm) | | | |

TABLE 2
v2 = 0.004 m/s

| | v2:v1 = 1:2 | v2:v1 = 1:3 | v2:v1 = 1:4 |
|---|---|---|---|
| | v1 = 0.008 m/s | v1 = 0.012 m/s | v1 = 0.016 m/s |
| droplet | 68 | 54 | 48 |
| size (μm) | | | |

TABLE 3
v1 = 0.016 m/s

| | v2:v1 = 1:2 | v2:v1 = 1:3 | v2:v1 = 1:4 |
|---|---|---|---|
| | v2 = 0.008 m/s | v2 = 0.00533 m/s | v2 = 0.004 m/s |
| droplet | 25 | 24 | 15-25 |
| size (μm) | | | |

TABLE 4
v2 = 0.004 m/s

| | v2:v1 = 1:2 | v2:v1 = 1:3 | v2:v1 = 1:4 |
|---|---|---|---|
| | v1 = 0.008 m/s | v1 = 0.012 m/s | v1 = 0.016 m/s |
| droplet | 30 | 22 | 15-25 |
| size (μm) | | | |

After comprehensive consideration of Table 1-Table 4, the following rules can be obtained: (1) Compared with changing the flow rate of the dispersed phase (water phase), changing the flow rate of the continuous phase (oil phase) is easier to affect the size of the generated droplets. (2)With the water phase flow rate unchanged, the oil phase flow rate is negatively correlated with the droplet size, but is nonlinear. (3) With the oil phase flow rate unchanged, the effect of the water phase flow rate on the droplet size is not positive correlation, that is, if the oil phase flow rate is constant, simply increasing the water phase flow rate does not necessarily increase the size of the generated droplets. (4) With the flow rate of any phase of liquid unchanged, the smaller the flow rate difference between the oil phase and the water phase is, the larger the droplet size is.

During actual operation, the range of droplet size adjusted by only considering the ratio of the second width to the first width can be expanded by controlling the flow rate ratio of the water phase to the oil phase. For example, the above obtained droplet size of 30-70 μm can be expanded to 15-70 μm by controlling the flow rate ratio of the water phase to the oil phase to 1:2-1:4 (as shown in Table 1-Table 4) , which can meet the requirements of droplet size for different single-cells.

According to some embodiments of the present disclosure, the volume variable part of the third flow channel extends a first length along the third direction, the volume variable part can be controlled to form a specific shape by adjusting the external conditions, and make the adjustable width gradually decrease and then increase along the first length. In some embodiments, the ratio of the minimum width to the maximum width may be between 0.5-1, for example, the ratio of the minimum width to the maximum width may be 0.5, 0.6, 0.7, 0.8, 0.9, and the first length may be 2-5 times of the minimum width, for example, 2, 3, 4, 5 times, etc. The droplet size can be controlled by controlling the configuration of the volume variable part. For a certain minimum width value, compared with the case that the entire length of the third flow channel has the minimum width value, the position of the minimum width at the upper and middle areas of the volume variable part has little impact on the droplet size, and the lower the position of the minimum width, the larger the size of the generated droplet. In the actual operation process, the specific configuration of the volume variable part can be adjusted according to the requirement, so as to control the droplet generation rate and droplet generation size more precisely.

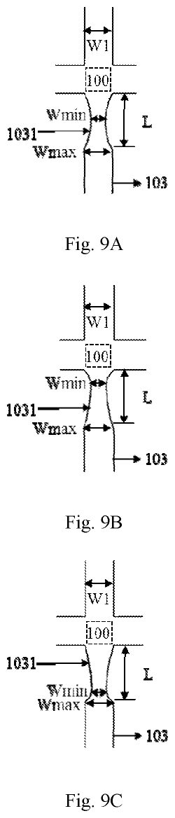

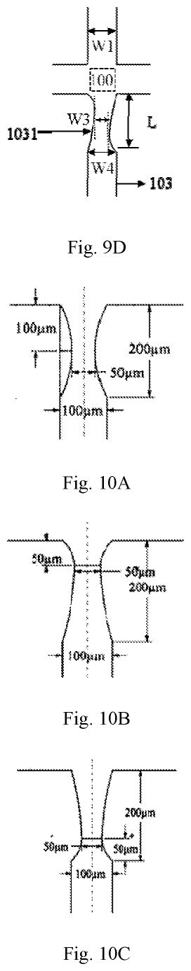

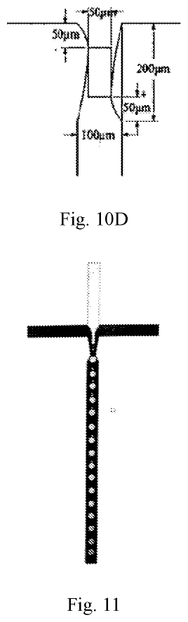

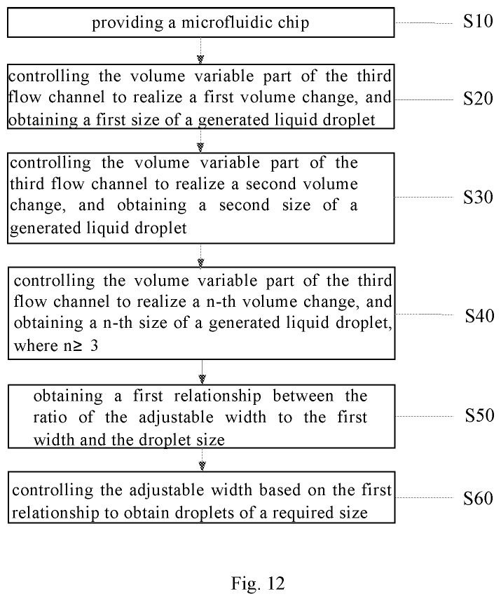

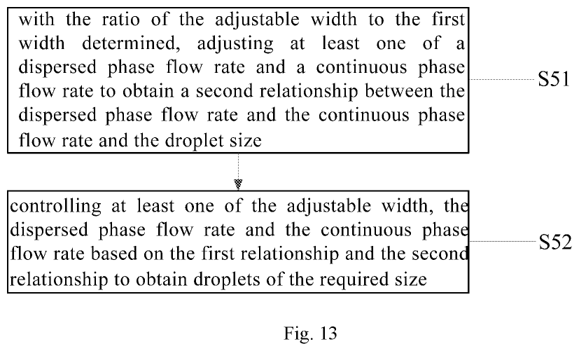

FIG. 9A shows another plan view of the flow channel structure of the microfluidic chip according to an embodiment of the present disclosure. As shown in FIG. 9A, the volume variable part 1031 of the third flow channel 103 extends the first length L along the third direction, and the adjustable width gradually decreases and then increases along the first length. The minimum width Wmin is half of the maximum width Wmax, the value of the first length L is 4 times of the value of the minimum width Wmin, the value of the maximum width Wmax may be equal to the value of the first width W1, and the position of the minimum width Wmin is at the midpoint of the first length. Specifically, as shown in FIG. 10A, the first length may be 200 microns, the maximum width may be 100 microns, the minimum width may be 50 microns, and the position of the minimum width is at the midpoint of the first length, that is, 100 microns from the edge of the confluence area adjacent to the third flow channel. Here, the configuration of the volume variable part 1031 shown in FIG. 10A is called configuration 1.

FIG. 9B shows another plan view of the flow channel structure of the microfluidic chip according to an embodiment of the present disclosure. As shown in FIG. 9B, the volume variable part 1031 of the third flow channel 103 extends the first length L along the third direction, and the adjustable width gradually decreases and then increases along the first length. The minimum width Wmin is half of the maximum width Wmax, the value of the first length L is 4 times of the value of the minimum width Wmin, the value of the maximum width Wmax may be equal to the value of the first width W1, and the position of the minimum width Wmin is closer to the confluence area 100 than the midpoint of the first length. Specifically, as shown in FIG. 10B, the first length may be 200 microns, the maximum width may be 100 microns, the minimum width may be 50 microns, and the position of the minimum width is closer to the confluence area than the midpoint of the first length, for example, 50 microns from the edge of confluence area adjacent to the third flow channel. Here, the configuration of the volume variable part 1031 shown in FIG. 10B is called configuration 2.

FIG. 9C shows another plan view of the flow channel structure of the microfluidic chip according to an embodiment of the present disclosure. As shown in FIG. 9C, the volume variable part 1031 of the third flow channel 103 extends the first length L along the third direction, and the adjustable width gradually decreases and then increases along the first length. The minimum width Wmin is half of the maximum width Wmax, the value of the first length L is 4 times of the value of the minimum width Wmin, the value of the maximum width Wmax may be equal to the value of the first width W1 , and the position of minimum width Wmin is farther from the confluence area 100 than the midpoint of the first length. Specifically, as shown in FIG. 10C, the first length may be 200 microns, the maximum width may be 100 microns, the minimum width may be 50 microns, and the position of the minimum width is at a position farther from the confluence area than the midpoint of the first length, for example, 150 microns from the edge of the confluence area adjacent to the third flow channel. Here, the configuration of the volume variable part 1031 shown in FIG. 10C is called configuration 3. FIG. 11 is a droplet distribution diagram of the channel structure with configuration 3 calculated by cfd. The size of the generated droplets is 40 microns, and the number of droplets in the flow channel is 16.

FIG. 9D shows another plan view of the flow channel structure of the microfluidic chip according to an embodiment of the present disclosure. As shown in FIG. 9D, the volume variable part 1031 of the third flow channel 103 extends the first length L along the third direction, and the adjustable width gradually decreases and then increases along the first length. The orthographic projection of the volume variable part on the substrate is a center-symmetric pattern, and a distance W3 between tangents of two curved edges of the center-symmetric pattern is half of the maximum distance W4 between the two curved edges. Here, the configuration of the volume variable part 1031 shown in FIG. 9D is called configuration 4. Specifically, as shown in FIG. 10D, the first length may be 200 microns, the distance between the tangents of the two curved edges of the center-symmetric pattern may be 50 microns, and the maximum distance between the two curved edges may be 100 microns.

The results of generating droplets using the above four configurations are shown in Table 5. The total number of droplets refers to the number of droplets generated within a certain period of time, and the number of droplets in the flow channel refers to the number of droplets in the flow channel at a certain time when the droplets are stably generated. It can be seen from Table 5 that controlling the configuration of the volume variable part can control the droplet generation rate and droplet generation size. The lower the position of the minimum width, the larger the size of the generated droplet is. For configuration 1 and configuration 2, the size of generated droplets is 34 microns and 32 microns respectively, which is close to the droplet size of 30 microns generated by the flow channel structure shown in FIG. 7A. It can be seen that the position of the minimum width at middle and upper part of the volume variable part has little effect on the droplet size. For configuration 3 and configuration 4, the size of the droplets generated is 46 microns and 40 microns respectively, which is significantly larger than that of the 30 microns generated by the channel structure shown in FIG. 7A. It can be seen that configuration 3 and configuration 4 can significantly increase the size of generated droplets. At the same time, by comparing the number of droplets generated by the four configurations in a certain time period, it can be seen that configuration 3 and configuration 4 can significantly slow down the generation rate of droplets. Therefore, the specific configuration of the volume variable part can be adjusted according to the requirements in the actual operation process to control the droplet generation rate and droplet generation size more precisely.

TABLE 5

| configuration | 1 | 2 | 3 | 4 |
|---|---|---|---|---|
| droplet size (μm) | 34 | 32 | 46 | 40 |
| total number of droplets | 64 | 63 | 26 | 33 |
| number of droplets in | 30 | 37 | 16 | 22 |
| the flow channel | | | | |

The volume variable part of the third flow channel of the above embodiments can include a volume phase change material. The volume phase change material can include at least one of a polymer brush, a polymer gel or an elastic material. The volume phase change material can be modified on the inner wall of the third flow channel. By controlling at least one of the magnetic field, electric field, temperature and pressure applied by the external condition, the adjustable width can be changed, thus controlling the ratio of the adjustable width to the first width, and then controlling the size of the generated droplets.

The present disclosure does not limit the specific components of the dispersed phase and the continuous phase that generate liquid droplets. The viscosity ratio of the continuous phase fluid to the dispersed phase fluid may be in a range of 10:1-50:1. After adding surfactant, the surface tension coefficient between dispersed phase and continuous phase may be in a range of 1×10⁻³˜1×10⁻² N/m.

According to another aspect of the present disclosure, a droplet generation device is provided. The droplet generation device comprises the microfluidic chip according to any one of the above embodiments. The droplet generation device may further comprise a pumping device, which is connected with the first flow channel and the second flow channel to control a flow rate of the dispersed phase entering the first flow channel and a flow rate of the continuous phase entering the second flow channel. By using the pumping device to accurately control the flow rate of the dispersed phase and the continuous phase, the size of the generated droplets can be adjusted more precisely.

According to yet another aspect of the present disclosure, a method for controlling a droplet generation size is provided. The method comprises the following steps:
S10: providing a microfluidic chip.

The microfluidic chip comprises a substrate and a first flow channel, a second flow channel and a third flow channel distributed on the substrate, the first flow channel, the second flow channel and the third flow channel intersecting to form a confluence area, the first flow channel being configured for a flow of a dispersed phase fluid from it, the second flow channel being configured for a flow of a continuous phase fluid from it, the dispersed phase fluid and the continuous phase fluid forming droplets in the third flow channel, wherein the dispersed phase fluid flows in the first flow channel along a first direction, an orthographic projection of the first flow channel on the substrate has a first width which is constant in a second direction, and the second direction and the first direction are perpendicular to each other in a plane of the substrate; the formed liquid droplets flow in the third flow channel along a third direction, the third flow channel comprises a volume variable part extending along the third direction, an orthographic projection of the volume variable part on the substrate has an adjustable width in a fourth direction, the fourth direction and the third direction are perpendicular to each other in the plane of the substrate, droplets of different sizes are generated by controlling a ratio of the adjustable width to the first width.
S20: controlling the volume variable part of the third flow channel to realize a first volume change, and obtaining a first size of a generated liquid droplet;
S30: controlling the volume variable part of the third flow channel to realize a second volume change, and obtaining a second size of a generated liquid droplet;
S40: controlling the volume variable part of the third flow channel to realize a n-th volume change, and obtaining a n-th size of a generated liquid droplet, where n≥3;
S50: obtaining a first relationship between the ratio of the adjustable width to the first width and the droplet size;
S60: controlling the adjustable width based on the first relationship to obtain droplets of a required size.

In some embodiments, after obtaining the first relationship between the ratio of the adjustable width to the first width and the droplet size, the method further comprises:
S51: with the ratio of the adjustable width to the first width determined, adjusting at least one of a dispersed phase flow rate and a continuous phase flow rate to obtain a second relationship between the dispersed phase flow rate and the continuous phase flow rate and the droplet size;
S52: controlling at least one of the adjustable width, the dispersed phase flow rate and the continuous phase flow rate based on the first relationship and the second relationship to obtain droplets of the required size.

Using the method provided in the present disclosure, the relationship curve between the ratio of the adjustable width to the first width and the size of the generated droplet is obtained under certain experimental conditions. In the subsequent experiments under the same experimental conditions, the flow channel structure can be selected or controlled relatively quantitatively according to the given relationship curve to generate the desired size of droplets. Thus, the problem of long droplet preparation time caused by replacing a large number of experimental chips with different structures is avoided, and the requirements for high throughput and automation in clinical detection are met.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another. Thus, a first element, component, region, layer or section discussed below could be termed a second element, component, region, layer or section without departing from the teachings of the present invention.

Spatially relative terms, such as “row”, “colum”, “lower”, “upper”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. Terms such as “before” or “preceding” and “after” or “followed by” may be similarly used, for example, to indicate an order in which light passes through the elements. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present. In no event, however, should “on” or “directly on” be construed as requiring a layer to completely cover an underlying layer.

Embodiments of the invention are described herein with reference to schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

As those skilled in the art will understand, although the various steps of the method in the present disclosure are described in a specific order in the accompanying drawings, this does not require or imply that these steps must be performed in the specific order, unless the context clearly indicates otherwise. Additionally or alternatively, multiple steps can be combined into one step for execution, and/or one step can be decomposed into multiple steps for execution. In addition, other method steps can be inserted between the steps. The inserted step may represent an improvement of the method such as described herein, or may be unrelated to the method. In addition, a given step may not be fully completed before the next step starts.

The above embodiments are only used for explanations rather than limitations to the present disclosure, the ordinary skilled person in the related technical field, in the case of not departing from the spirit and scope of the present disclosure, may also make various modifications and variations, therefore, all the equivalent solutions also belong to the scope of the present disclosure, and the patent protection scope of the present disclosure should be defined by the claims.

1. A microfluidic chip, comprising:
a substrate and a first flow channel, a second flow channel and a third flow channel distributed on the substrate, the first flow channel, the second flow channel and the third flow channel intersecting to form a confluence area, the first flow channel being configured for a flow of a dispersed phase fluid from it, the second flow channel being configured for a flow of a continuous phase fluid from it, the dispersed phase fluid and the continuous phase fluid forming droplets in the third flow channel,
wherein the dispersed phase fluid flows in the first flow channel along a first direction, an orthographic projection of the first flow channel on the substrate has a first width which is constant in a second direction, and the second direction and the first direction are perpendicular to each other in a plane of the substrate,
wherein the droplets flow in the third flow channel along a third direction, the third flow channel comprises a volume variable part extending along the third direction,
wherein an orthographic projection of the volume variable part on the substrate has an adjustable width in a fourth direction,
wherein the fourth direction and the third direction are perpendicular to each other in the plane of the substrate, and
wherein the droplets are of different sizes and are generated by controlling a ratio of the adjustable width to the first width.

2. The microfluidic chip according to claim 1, wherein the adjustable width has a second width which is constant along the third direction.

3. The microfluidic chip according to claim 2, wherein the first direction is in a same line with the third direction.

4. The microfluidic chip according to claim 3, wherein a ratio of the second width to the first width is between 0.5-1.

5. The microfluidic chip according to claim 4, wherein a droplet size is approximately linear with the ratio of the second width to the first width.

6. The microfluidic chip according to claim 5, wherein a viscosity ratio of the continuous phase fluid to the dispersed phase fluid is in a range of 10:1-50:1, and a surface tension coefficient between the continuous phase fluid and the dispersed phase fluid after adding surfactant is in a range of 1×10⁻³˜1×10⁻² N/m, the droplet size is approximately positively correlated linear with the ratio of the second width to the first width.

7. The microfluidic chip according to claim 1, wherein the volume variable part extends a first length along the third direction, and the adjustable width gradually decreases and then increases along the first length.

8. The microfluidic chip according to claim 7, wherein a ratio of a minimum width to a maximum width is between 0.5-1, and the first length is 2-5 times the minimum width.

9. The microfluidic chip according to claim 8, wherein the maximum width is equal to the first width.

10. The microfluidic chip according to claim 8, wherein the minimum width is at a midpoint of the first length.

11. The microfluidic chip according to claim 8, wherein the minimum width is at a position closer to the confluence area than a midpoint of the first length.

12. The microfluidic chip according to claim 8, wherein the minimum width is at a position farther from the confluence area than a midpoint of the first length.

13. The microfluidic chip according to claim 7, wherein the orthographic projection of the volume variable part on the substrate is a center-symmetric pattern, and a distance between tangents of two curved edges of the center-symmetric pattern is half of a maximum distance between the two curved edges.

14. (canceled)

15. The microfluidic chip according to claim l, wherein the volume variable part of the third flow channel comprises volume phase change material.

16. The microfluidic chip according to claim 15, wherein the volume phase change material achieves the adjustable width in response to at least one condition change in magnetic field, electric field, temperature and pressure.

17. (canceled)

18. The microfluidic chip according to claim 1, wherein a dispersed phase of the dispersed phase fluid is an aqueous phase, a continuous phase of the continuous phase fluid is an oil phase, and the droplets have a water-in-oil structure.

19. A droplet generation device, comprising the microfluidic chip according to claim 1.

20. The droplet generation device according to claim 19, further comprising a pumping device, which is connected with the first flow channel and the second flow channel to control a flow rate of the dispersed phase fluid entering the first flow channel and a flow rate of the continuous phase fluid entering the second flow channel.

21. A method for controlling a droplet generation size, comprising:
providing the microfluidic chip according to claim 1;
controlling the volume variable part of the third flow channel to realize a first volume change, and obtaining a first size of a generated liquid droplet;
controlling the volume variable part of the third flow channel to realize a second volume change, and obtaining a second size of a generated liquid droplet;
controlling the volume variable part of the third flow channel to realize a n-th volume change, and obtaining a n-th size of a generated liquid droplet, where n>3;
obtaining a first relationship between the ratio of the adjustable width to the first width and the droplet size; and
controlling the adjustable width based on the first relationship to obtain droplets of a required size.

22. The method according to claim 21, after obtaining the first relationship between the ratio of the adjustable width to the first width and the droplet size, further comprising:
with the ratio of the adjustable width to the first width determined, adjusting at least one of a dispersed phase flow rate and a continuous phase flow rate to obtain a second relationship between the dispersed phase flow rate and the continuous phase flow rate and the droplet size; and
controlling at least one of the adjustable width, the dispersed phase flow rate and the continuous phase flow rate based on the first relationship and the second relationship to obtain droplets of the required size.

23. (canceled)
